(19) United States
(12) Patent Application Publication
(10) Pub. No.: US 2011/0001823 A1
(43) Pub. Date: Jan. 6, 2011

(54) Method for Detecting a Target

(75) Inventors: Jean-Yves Dufour, Montigny le Bretonneux (FR); Michel Prenat, Boulogne (FR); Nadege Lemperiere, Issy les Moulineaux (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/739,469

(22) PCT Filed: Oct. 24, 2008
(86) PCT No.: PCT/EP08/64436

§ 371 Date: Jul. 7, 2010

(30) Foreign Application Priority Data
Oct. 26, 2007 (FR) 07 07561

(51) Int. Cl. G06K 9/62; H04N 7/18

(52) U.S. Cl. 348/143; 382/103; 348/E07.085

(57) ABSTRACT

The invention relates to a method for detecting a target in a scene comprising: a step of acquiring digital images of the scene by means of a sensor, these images comprising pixels, then, for each pixel: —a step of estimating the background of the pixel, —a step of estimating the signal-to-noise ratio of the pixel, —a decision step by thresholding this signal-to-noise ratio to determine whether the pixel is a pixel of the target. The step of estimating the background of the pixel is based on the selection, for each pixel, of a so-called neighboring area, centered around the pixel, this area satisfying a predetermined uniformity criterion and the size of this area being as close as possible to a predetermined maximum size.

The field of the invention is that of surveillance systems.

The function of a surveillance system is to detect and follow targets penetrating into a surveillance area.

The crucial problem of target detection in a video sequence is to find a criterion, called “detection criterion”, that can be used to decide, for each image comprising pixels, which are the pixels of a target. The choice of this criterion leads to detection performance levels defined as a function of the pairing of detection probability and false alarm probability.

It will be recalled that the detection probability is the probability for a pixel of a target of being considered to be probably that of a target; the false alarm probability is the probability for a pixel of a non-threatening object of being selected as being probably that of a target.

In the air target surveillance systems, images are generally used that are acquired in the infrared wavelengths because they offer a good detection criterion inasmuch as most of the targets are propelled and therefore provide a high IR signal.

This signal is expressed as follows depending on whether a target is present or not in the corresponding pixel.

Sₜₕᵣₑₐₜ=S_{target}+S_{background}+Sₙₒᵢₛₑ

Sₙₒ₋ₜₕᵣₑₐₜ=S_{background}+Sₙₒᵢₛₑ

in which S_{target} is the target signal, S_{background} is the signal from the background of the pixel (also known as the background), Sₙₒᵢₛₑ is a random sample of the noise from the sensor.

The detection criterion for IR images is given by the SNR of the IR signal specific to the target. The signal-to-noise ratio of a target is given by:

$${SNR}_{threat} = \frac{{S}_{target}}{σ ( {S}_{noise} )}$$

in which σ(Sₙₒᵢₛₑ) is the standard deviation of the noise of the sensor.

According to this definition, a target therefore has a non-zero signal-to-noise ratio, whereas a background object has a zero signal-to-noise ratio. This criterion can therefore be used to separate the targets from the background by simple thresholding.

An estimator of the signal-to-noise ratio in a given pixel can be obtained from the signal collected in this pixel by:

$$〈 RSB 〉 = \frac{S - 〈 {S}_{background} 〉}{σ ( {S}_{noise} )}$$

where <S_{background}> is the estimated signal of S_{background}.

The following are therefore obtained:

$$〈 {RSB}_{threat} 〉 = \frac{{S}_{threat} - 〈 {S}_{background} 〉}{σ ( {S}_{noise} )} = \frac{\begin{matrix}{S}_{target} + {S}_{background} - \\ 〈 {S}_{background} 〉 + {S}_{noise}\end{matrix}}{σ ( {S}_{noise} )}$$

$$〈 {RSB}_{no \text{-} threat} 〉 = \frac{{S}_{no \text{-} threat} - 〈 {S}_{background} 〉}{σ ( {S}_{noise} )} = \frac{\begin{matrix}{S}_{background} - \\ 〈 {S}_{background} 〉 + {S}_{noise}\end{matrix}}{σ ( {S}_{noise} )}$$

The quality of the estimator is closely linked to the quality of the estimator of the background of the target. However, even if this estimation is perfect, there remains a noise term which can cause:
a non-threatening pixel to have a non-zero SNR because of the production of noise on the current pixel, thus inducing a false alarm,
a threatening pixel to have an SNR below that provided, even below that of the threshold, thus inducing a non-detection of a target.

One method of detecting targets in a pixel in the infrared spectral band is therefore to estimate, in each pixel, its signal-to-noise ratio, then to decide that the pixel is a target if this estimated signal-to-noise ratio exceeds a fixed threshold.

There is therefore still the problem of finding a good estimation of the background of the pixel being studied when it is mixed with the signal from the target in the infrared signal from the pixel being studied.

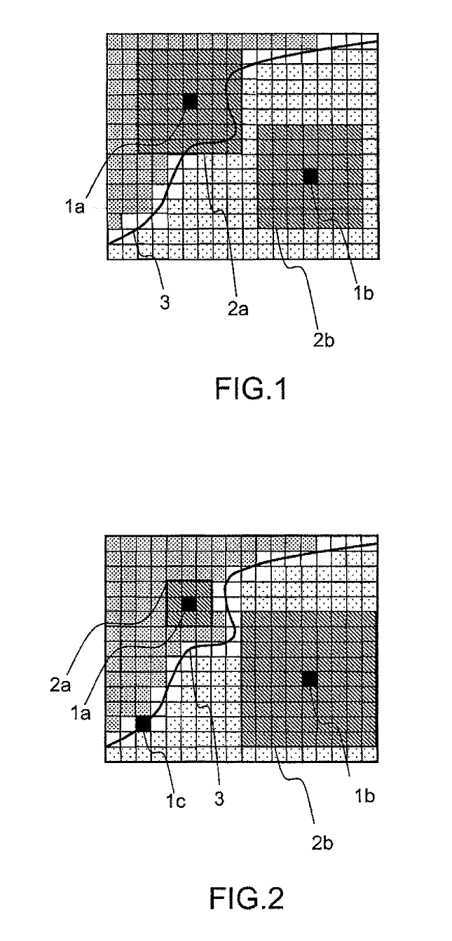

It is known practice to estimate the background signal by considering the average of a background of fixed size, that is to say, the average of a fixed number of pixels uniformly located around the pixel being studied. This method does not take into account the bias resulting from the statistical estimation of the background signal over a reduced number of pixels. Finally, this method applies badly to the characterization of the background of complex scenes: if the estimated background contains information that does not correspond to the real background of the pixel being studied, the estimation of the background signal is errored. This drawback is illustrated in FIG. 1 which shows two pixels being studied 1a and 1b, and the corresponding backgrounds 2a and 2b which have the same fixed size, in this case 7×7 pixels. One of these backgrounds 2a cuts a boundary 3 which represents the separation between the backgrounds 2a and 2b, so that background 2a is not uniform.

This may be reflected in a poor estimation of the SNR of the pixels leading to an increase in the false alarm probability and therefore to a reduction in performance levels.

The proposed solution is to use, around the pixel being studied, an area (or background) called neighboring area, whose size is suited to the complexity of the local scene. This size is calculated by using a uniformity criterion to locally select the biggest quasi-uniform area for the estimation of the background. The task then amounts to analyzing a quasi-uniform background, that is to say, a conventional bias estimation problem.

This is illustrated in FIG. 2. The size of the neighboring area 2a of the pixel 1a is smaller (3×3 pixels) than that (2b) of the pixel 1b (9×9 pixels), the pixel 1a being closer to the boundary 3 than the pixel 1b. In the limit case of the pixel 1c, the neighboring area is reduced to this pixel since it is situated on the boundary 3.

More specifically, the subject of the invention is a method for detecting a target in a scene comprising:
a step of acquiring digital images of the scene by means of a sensor, these images comprising pixels,

then, for each pixel:
a step of estimating the background of the pixel,
a step of estimating the signal-to-noise ratio of the pixel,
a decision step by thresholding this signal-to-noise ratio to determine whether the pixel is a pixel of the target.

It is mainly characterized in that the step of estimating the background of the pixel is based on the selection, for each pixel, of a so-called neighboring area, centered around said pixel, this area satisfying a predetermined uniformity criterion and the size of this area being as close as possible to a predetermined maximum size.

There is thus obtained a non-bias estimation for a large quasi-uniform background. For the pixels being studied close to the limits of a complex background, the size of the neighboring area is reduced: the bias of the estimation is, however, very much less than that which would result from the inclusion of these limits in the estimation of the background.

According to one characteristic of the invention, the selection of the neighboring area is based on the calculation of an intensity plane centered around said pixel and of which the standard deviation of the remainder is less than a predetermined threshold Su.

According to a characteristic of the invention, the selection of the neighboring area comprises the following steps consisting in:
A) calculating the parameters of the closest intensity plane,
B) calculating a term associated with the standard deviation of the remainder of said plane,
C) when this term reaches a predetermined threshold Su, the size of the area is retained, otherwise the steps A, B and C are repeated based on a modified area size.

According to one characteristic of the invention, the closest intensity plane is calculated by the least squares method.

The predetermined size is, for example, the maximum size and, in the step C, the size of the modified area is a reduced size.

According to one characteristic of the invention, in the step A, one of the parameters is calculated from the average intensity of said area.

According to one embodiment of the invention, the neighboring area, centered around the pixel, excludes said pixel.

The invention that is described optimally detects targets that occupy only one pixel. According to one characteristic of the invention, the step of estimating the background for each pixel is preceded by a step of changing the scale of the pixels, that is to say that a block of q×q old pixels (or original pixels) becomes a new pixel, q being an integer greater than or equal to 2. This makes it possible to detect the targets that occupy more than one original pixel, by averaging by blocks of the image until the targets that are to be detected occupy only one new pixel.

Another subject of the invention is a system for detecting a target in a scene, comprising a sensor of digital images of the scene, an image processing unit, characterized in that the processing unit comprises means of implementing the method as claimed in one of the preceding claims.

Other features and benefits of the invention will become apparent from reading the following detailed description, given as a non-imiting example, and with reference to the appended drawings in which:

FIG. 1, already described, illustrates the problem posed by backgrounds of fixed size,

FIG. 2 illustrates the solution proposed by the invention, namely neighboring areas of suitable size,

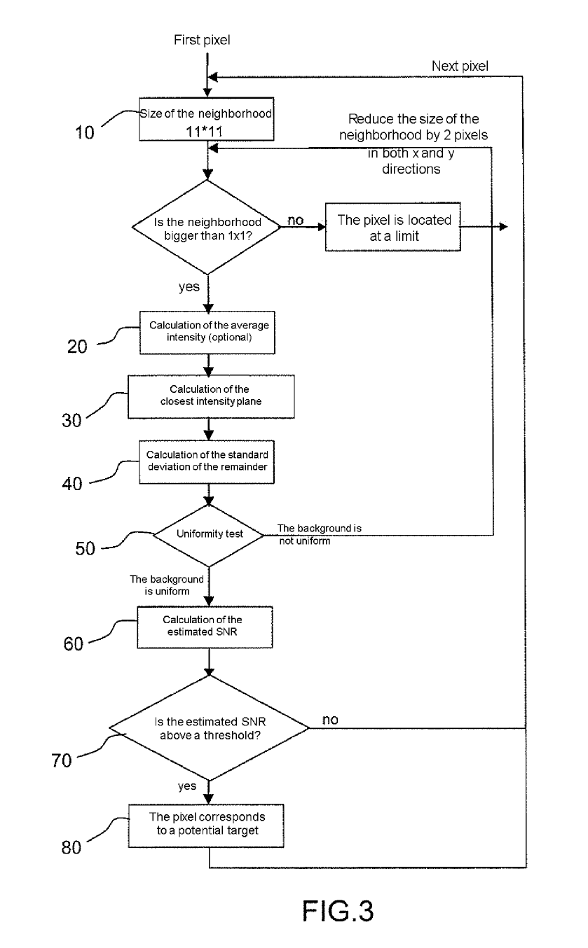

FIG. 3 is a flow diagram of the various steps of an example of how the method according to the invention runs,

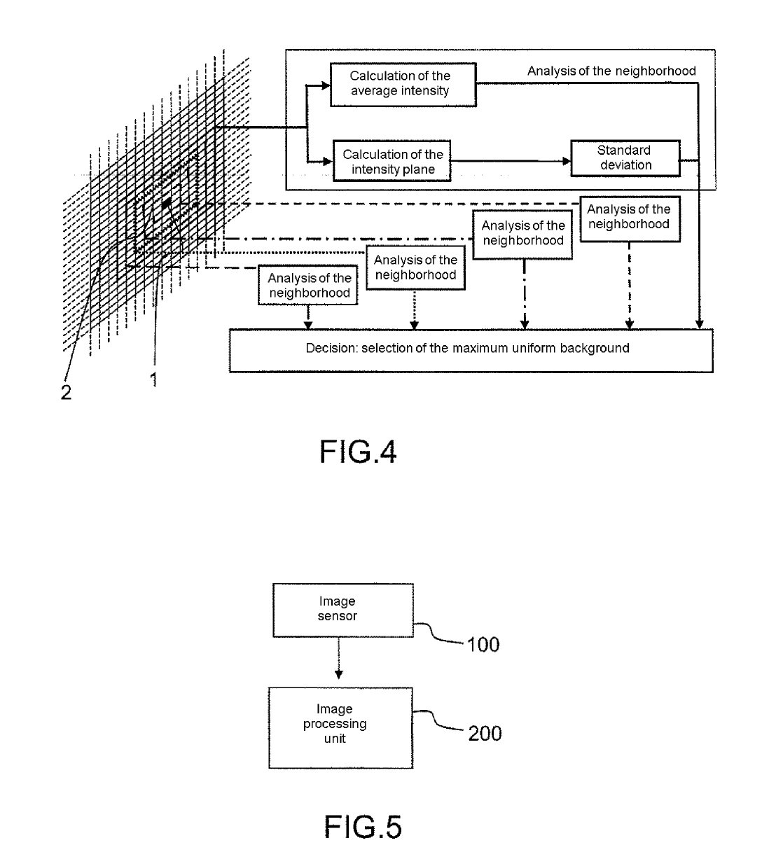

FIG. 4 diagrammatically illustrates the application of the method according to the invention to a pixel being studied,

FIG. 5 diagrammatically represents a detection system according to the invention.

From one figure to another, the same elements are identified by the same references.

According to the invention, the step of estimating the pixels of the background of the target is based on the selection, for each pixel of the image, of a so-called neighboring area, centered around the pixel: this area is the largest possible uniform area. An area is uniform when it satisfies a predetermined uniformity criterion, in this case when it can be adjusted by an intensity plane for which the standard deviation, or more specifically the standard deviation of the remainder, is below a predetermined threshold. This threshold is, for example, equal to the standard deviation of the noise of the sensor multiplied by a determined coefficient. The calculated plane of intensity is that which best approaches the distribution of the intensities in the pixels of the area concerned. Also calculated is the “standard deviation” of the closest intensity plane, or more specifically the “standard deviation of the remainder”, which is the square root of the average of the squares of the deviations between, for each pixel of the area, the intensity in this pixel and the intensity of the closest intensity plane in this pixel.

Another uniformity criterion consists, for example, in thresholding the nth order intensity moments of the pixels, or even in constructing the histogram of the pixels and in correlating it with a gaussian probability distribution. These three uniformity criteria are examples of uniformity criteria based on one or more empirical statistical characteristics calculated from the intensities of the pixels of the area under consideration. An empirical (or even sampled) characteristic is a characteristic which can be calculated from a sample of a random variable or of a random process. For example, the empirical average of a sample x₁, . . . , xₙ is equal to mₑ=1/n Σ(of i=1 to n) [xi], and constitutes an estimator of the average of the random variable for which the series x₁, . . . , xₙ is a sample. Similarly, a histogram constitutes an estimator of the probability distribution of a random variable, obtained from a sample of this variable, and is in this respect an empirical statistical characteristic. The solution retained was retained for its low algorithmic complexity; it is better suited to real time operation.

The selection of this area will be described in relation to the flow diagram of FIG. 3. For each pixel of the image, designated “first pixel” or “next pixel”, an area of size N×N pixels is chosen around this pixel (step 10).

According to a first embodiment, a choice is made on each iteration to reduce the size of the area and the first area encountered which satisfies a uniformity criterion is selected. In this case, the size of the area chosen on the first iteration is the largest possible. In the example of the figure, the maximum size of the area is Nₘ×Nₘ pixels with Nₘ being such that:
Nₘ is odd
Nₘ is less than or equal to N_{M}=11
There is an area of size Nₘ×Nₘ pixels included in the image being processed, and centered around the pixel being studied, which makes it possible to process the case of the pixels situated at the periphery of the image, that is to say those that do not have a neighborhood of size 11×11 pixels totally included in the image.
   N_{M}×N_{M}=11×11 pixels therefore corresponds to the largest of all the areas that will be tested.

With N being fixed, a number of steps are then carried out in sequence.

The step 20 consists in calculating the average intensity of this area.

According to one embodiment of the invention, the pixel being studied is included in the neighboring area. The average intensity m is then given by the formula:

m=ΣI(x,y)/N²

I(x,y) being the intensity of a pixel of coordinates x, y, the sum of the intensities being calculated over the area concerned, it is therefore indexed by the coordinates x and y of the pixels of this area, and N² being the number of pixels in the area concerned. N² is equal to Nₘ×Nₘ for the 1st area.

According to another embodiment of the invention, the pixel being studied is excluded from the neighboring area. The average intensity m is then given by the formula:

m=ΣI(x,y)/(N²−1)

The next step (step 30) consists in calculating an intensity plane. For this, each pixel is assigned a pair of coordinates (x,y) according to the following law:

The neighbor to the right of a pixel of coordinates (x,y) has the coordinates (x+1,y).

The neighbor below a pixel of coordinates (x,y) has the coordinates (x,y+1).

All that is then needed is to fix the coordinates (x,y) of any point of the neighborhood, arbitrarily, to then be able to construct a tiling of the neighborhood suitable for estimating the local plane.

The issue is then to find the intensity plane defined by the parameters a, b and c, and such that I(x,y) is as close as possible to ax+by+c at any point of the above tiling. These parameters are estimated, for example, by resolution in the least squares sense. It would also be possible to use more complex methods such as weighted least squares that make it possible to automatically exclude the aberrant points of the neighborhood from the estimation of the plane. However, for computation time reasons, it has been chosen in this description to use the resolution in the least squares sense.

Estimated values of the parameters a, b and c, or aₑ, bₑ and cₑ, are calculated in such a way that the sum

D=Σ(I(x,y)−(ax+by+c))²

which is a function of a, b and c, is minimum for a=aₑ, b=bₑ and c=cₑ, this sum being calculated over the neighboring area. D is the sum, over the pixels of said area, of the squares of the differences for each pixel between its intensity and that of a given intensity plane.

This is obtained by resolving the following system.

δD/δa=0, δD/δb=0, δD/δc=0, in which the symbol δ designates the partial derivative, or

$$\{ \begin{matrix}\sum [ ( I ( x , y ) - ( {a}_{e} x + {b}_{e} y + {c}_{e} ) ) \cdot ( - x ) ] = 0 \\ \sum [ ( I ( x , y ) - ( {a}_{e} x + {b}_{e} y + {c}_{e} ) ) \cdot ( - y ) ] = 0 \\ \sum [ ( I ( x , y ) - ( {a}_{e} x + {b}_{e} y + {c}_{e} ) ) \cdot ( - 1 ) ] = 0\end{matrix}$$

which leads to a system of three linear equations in aₑ, bₑ and cₑ, or, mathematically:

(aₑ,bₑ,cₑ)=argmin_{a,b,c}D(a,b,c)

in which argmin_{a,b,c} of a function f(a,b,c) designates the triplet of values of a,b,c that minimizes f.

One interesting feature is that, if the central pixel of the neighboring area has received the coordinates (0,0), then the coefficient c of the estimated plane, or cₑ, is equal to the average intensity in the neighborhood, m, defined in the step 20, because, in this case, Σ(X)=Σ(y)=0. cₑ is then calculated by the simple formula:

cₑ=ΣI(x,y)/N² or cₑ=ΣI(x,y)/(N²−1)

depending on whether the pixel being studied is included in the area or excluded from the area.

Thus, the system of three linear equations is reduced to a system of two linear equations in aₑ and bₑ, that can be rewritten in the form:

aₑΣ(x²)+bₑΣ(xy)=Σ[xI(x,y)]

aₑΣ(xy)+bₑΣ(y²)=Σ[yI(x,y)]

For example, the respective intensities of the pixels of an area of 3×3 pixels centered on the pixel of coordinates (0,0) are: I(−1,1), I(0,1), I(1,1), I(−1,0), I(0,0), . . . I(−1,−1).

The coefficients aₑ, bₑ and cₑ of the closest intensity plane being determined, the next step (step 40) consists in calculating the standard deviation of the remainder, that is to say min_{a,b,c} (D)=D (aₑ, bₑ, cₑ) then the standard deviation of the remainder σᵣ=(Dₘᵢₙ/N²)^{1/2} or σᵣ=(Dₘᵢₙ/(N²−1))^{1/2} depending on whether the pixel being studied is included in the area or excluded from the area.

The next step (step 50), the uniformity test step, is then applied. This consists in comparing the standard deviation of the remainder σᵣ to a predetermined threshold Su (threshold for the uniformity test); this threshold is an adjustable parameter. It is, for example, equal to the standard deviation of the noise of the sensor multiplied by a determined coefficient so that an image consisting only of the noise of the sensor is analyzed as uniform with a probability close to 1. If the standard deviation of the remainder (or more generally a term linked to the standard deviation of the remainder), is greater than the threshold (σᵣ>Su), this means that the background is not uniform over this neighboring area. The size of the area is then reduced, and the steps 20, 30, 40 and 50 are repeated until the uniformity criterion is reached. There are, for example, N×N=9×9 for the 2nd area (2nd iteration) on a pixel with an initial value of N equal to 11 (Nₘ=11).

If the standard deviation of the remainder is less than or equal to the threshold (σ≦Su), this means that the background is uniform over this neighboring area which becomes the selected area.

More generally, any odd value greater than 1 is chosen for the value of N_{M}. The value N_{M}=11 is the value below which the performance levels significantly deteriorate, whereas the gain in performance when N_{M} is increased becomes negligible above 11. For a best performance/computation time trade-off, the following is chosen:

Nₘ=11.

According to another embodiment, the choice is made upon each iteration to increase the size of the area, by then taking an initial area size of 3×3 pixels and selecting the last area encountered such that:

this area is entirely included in the image

its size does not exceed Nₘ×Nₘ pixels

it satisfies the uniformity criterion.

As indicated previously, the calculation of the signal-to-noise ratio estimated for the pixel being studied satisfies the formula:

$$〈 SNR 〉 = \frac{S - 〈 {S}_{background} 〉}{σ ( {S}_{noise} )}$$

in which <S_{background}>is the estimated value of the background at the pixel being studied (of coordinates x_{c}, yₑ), or

<S_{background}>=aₑx_{c}+bₑy_{c}+cₑ

and in which σ(Sₙₒᵢₛₑ) is the standard deviation of the noise of the sensor.

The numerator of <SNR> is therefore equal to

I(x_{c},y_{c})−<S_{background}>=I(x_{c},y_{c})−(aₑx_{c}+bₑy_{c}+cₑ)

This estimated signal-to-noise ratio is compared to a threshold Sd (threshold for detection, step 70). If it is greater as an absolute value, the pixel being studied (xc,yc) is marked as corresponding to a potential target (step 80); otherwise, it is eliminated from the rest of the processing operation, and will not be considered as a potential target. Then, the method goes on to another pixel to be studied.

When no uniform neighboring area can be selected, that is to say when the area is reduced to the pixel being studied, this means that this pixel is probably located on a limit (like the pixel 1c in FIG. 2) and it is then identified as such. The specific processing for this type of pixel is not part of the method which is the subject of this patent application.

FIG. 4 shows an area of the image around a pixel 1 representative of the target. This figure illustrates the case where the initial area has a size of 11×11 pixels and the uniform area 2 which is the 5th area selected, has a size of 3×3 pixels. The analysis of the neighborhood combines the steps 20, 30 and 40. The selection of the maximum uniform background combines the step 50 and possible loopback on the size of the neighborhood.

The invention described hitherto detects targets which occupy only one pixel. A possible adaptation of the invention makes it possible to detect targets with a size greater than one pixel, by averaging by blocks of the image (called “new pixels”) until the targets that are to be detected occupy only one new pixel.

If, for example, only the maximum size of the targets to be detected is known, it is thus possible to analyze consecutively images averaged by blocks 2×2, 3×3, . . . up to p×p, which amounts to “zooming out” from the image, that is to say to changing the scale of the frame O,x,y of the image: a block of q×q old pixels becomes one new pixel, q being an integer greater than or equal to 2 and possibly ranging up to the number p which corresponds to the maximum size of the targets to be detected. This step occurs before all of the background estimation steps described previously and which lead to an announcement as to whether the pixel corresponds to a potential target.

It is then possible to merge the detected pixels (which, a priori, have different sizes) using a connectivity algorithm.

A detection system according to the invention represented in FIG. 5 comprises a digital image sensor 100 and a unit 200 for processing these images which comprises conventional means for implementing the method described.

1. A method for detecting a target in a scene comprising:
a step of acquiring digital images of the scene by means of a sensor, these images comprising pixels,
then, for each pixel:
a step of estimating the background of the pixel,
a step of estimating the signal-to-noise ratio of the pixel,
a decision step by thresholding this signal-to-noise ratio to determine whether the pixel is a pixel of the target,
characterized in that the step of estimating the background of the pixel is based on the selection, for each pixel, of a so-called neighboring area, centered around the pixel, this area satisfying a predetermined uniformity criterion based on one or more empirical statistical characteristics calculated from the intensities of the pixels of the area concerned, and the size of this area being as close as possible to a predetermined maximum size.

2. The method for detecting a target as claimed in the preceding claim, characterized in that the uniformity criterion is based on the calculation of an intensity plane centered around said pixel and of which the standard deviation of the remainder is less than a predetermined threshold Su.

3. The method for detecting a target as claimed in the preceding claim, characterized in that the selection of the neighboring area comprises the following steps consisting in:
A) calculating the parameters of the intensity plane closest to an area of predetermined size,
B) calculating a term associated with the standard deviation of the remainder of this plane,
C) when this term reaches a predetermined threshold, the size of the area is retained, otherwise the steps A, B and C are repeated based on a modified area size.

4. The method for detecting a target as claimed in the preceding claim, characterized in that the closest intensity plane is calculated by the least squares method.

5. The method for detecting a target as claimed in one of claims 3 and 4, characterized in that, in the step A, one of the parameters is calculated from the average intensity of the area of predetermined size.

6. The method for detecting a target as claimed in one of claims 3 to 5, characterized in that the predetermined size is the maximum size and in that, in the step C, the modified area size is a reduced size.

7. The method for detecting a target as claimed in claim 1, characterized in that the uniformity criterion is based on the calculation of the nth order intensity moments of the pixels.

8. The method for detecting a target as claimed in claim 1, characterized in that the uniformity criterion is based on the calculation of the pixel intensity histogram.

9. The method for detecting a target as claimed in one of the preceding claims, characterized in that it comprises, before the step of estimating the background for each pixel, a step of changing the scale of the pixels, that is to say that a block of q×q old pixels becomes a new pixel, q being an integer greater than or equal to 2.

10. The method for detecting a target as claimed in one of the preceding claims, characterized in that the neighboring area centered around the pixel excludes said pixel.

11. A system for detecting a target in a scene, comprising a sensor (100) of digital images of the scene, an image processing unit (200), characterized in that the processing unit comprises means of implementing the method as claimed in one of the preceding claims.
